(19) United States
(12) Patent Application Publication
(10) Pub. No.: US 2023/0413917 A1
(43) Pub. Date: Dec. 28, 2023

(54) REUSABLE AEROSOL-GENERATING ARTICLE WITH A COMPARTMENT FOR THE AEROSOL-FORMING SUBSTRATE

(71) Applicant: Philip Morris Products S.A., Neuchatel (CH)

(72) Inventors: Clement BESSO, Neuchatel (CH); Ricardo CALI, Mannheim (DE); Wanjiang HAN, La Tene (CH); Toney Moses RAJAN, Mannheim (DE)

(73) Assignee: Philip Morris Products S.A., Neuchatel (CH)

(21) Appl. No.: 18/253,434

(22) PCT Filed: Nov. 24, 2021
(86) PCT No.: PCT/EP2021/082834

§ 371 Date: May 18, 2023

(30) Foreign Application Priority Data
Nov. 27, 2020 (EP) 20210202.6

(51) Int. Cl. A24F 40/485; A24F 40/20; A24F 40/465; A24F 40/42

(52) U.S. Cl. CPC A24F 40/485; A24F 40/20; A24F 40/465; A24F 40/42

(57) ABSTRACT

A reusable aerosol-generating article configured to be received into a cavity of an aerosol-generating device is provided, the reusable aerosol-generating article including: a housing including a compartment configured to receive an aerosol-forming substrate and an air-flow tube arranged downstream of the compartment, at least parts of the housing being pivotable about a hinge and configured to provide access to the compartment and the air-flow tube. An aerosol-generating system, including an aerosol-generating device including a cavity, and the reusable aerosol-generating article, is also provided.

The present invention relates to a reusable aerosol-generating article. The present invention further relates to a system for generating an aerosol including the reusable aerosol-generating article and an aerosol-generating device. The present invention further relates to the use of the aerosol-generating article for the formation of an aerosol.

Aerosol-generating devices are known which heat but do not burn aerosol-forming substrates in aerosol-generating articles such as tobacco. Such devices heat the aerosol-forming substrates to a sufficiently high temperature for generating an aerosol for inhalation by the user. These aerosol-generating devices normally include a cavity for receiving the aerosol-forming substrates. These devices are typically portable, hand-held devices and are generally compact.

Aerosol-forming articles normally contain an aerosol-forming substrate including an aerosol former such as, for example, substrate material such as tobacco. The aerosol-forming articles often include additional elements, such as filters, hollow tubular portions, such as hollow cellulose acetate tubes (HAT) and a mouthpiece. After use, these aerosol-forming articles are discarded and replaced, resulting in a large amount of waste. Additionally, residue from the aerosol-forming articles is often deposited in the cavity of the aerosol-generating devices, impairing the function of these devices. These deposits in the cavity can also compromise the taste experienced by a user during aerosol-consumption.

It would be desirable to provide a reusable aerosol-generating article reducing the amount of waste. It furthermore would be desirable to provide an aerosol-generating article which is cleanable or washable and which reduces the amount of deposits in the cavity of the aerosol-generating devices.

According to an embodiment of the present invention there is provided a reusable aerosol-generating article which may be configured for being received into a cavity of an aerosol-generating device. The reusable aerosol-generating article may comprise a housing, the housing may comprise a compartment for receiving an aerosol-forming substrate. At least parts of the housing may be pivotable about a hinge for providing access to the compartment.

According to another embodiment of the present invention there is provided a reusable aerosol-generating article which is configured for being received into a cavity of an aerosol-generating device. The reusable aerosol-generating article comprises a housing, the housing comprising a compartment for receiving an aerosol-forming substrate. The housing may be configured to allow a used aerosol-forming substrate to be removed and replaced by another aerosol-forming substrate. At least parts of the housing are pivotable about a hinge for providing access to the compartment.

Such a reusable aerosol-generating article may reduce the amount of residues, in particular from aerosol-forming substrate deposited in the cavity of the aerosol-generating device. Residues may be deposited in the reusable aerosol-generating article instead of directly in the aerosol-generating device. The compartment being accessible by pivoting parts of the housing about a hinge may easily be cleaned. It may be easier to clean the reusable aerosol-generating article and in particular its compartment in comparison to the cavity of the aerosol-generating device, which is often buried within the device and is not easily accessible. For example, the reusable aerosol-generating article may be able to be opened about a hinge to allow a user to access the cavity for cleaning. In addition, the reusable aerosol-generating article may be amenable to cleaning using, for example, a dishwasher. Employing such a reusable aerosol-generating article may reduce the amount of waste introduced into the environment. In particular, only the aerosol-forming substrate may be replaced by opening the compartment and discarding the substrate. The aerosol-generating article comprising the housing and the compartment may be re-used multiple times and the compartment may be re-filled with fresh aerosol-forming substrate. Elements of a typical aerosol-forming substrate, including for example, a filter, hollow tubular portions such as hollow cellulose acetate tubes (HAT), spacers, a mouthpiece or other elements, may be incorporated into the reusable aerosol-generating article instead of provided with the aerosol-forming substrate. Therefore, when the aerosol-forming substrate is discarded after use, the filter, hollow tubular portions, tubes, spacers and mouthpieces that are not present, are not discarded. Therefore, there is less waste.

In a further embodiment of the invention the reusable aerosol-generating article may further comprise a mouthpiece. A user may puff on the mouthpiece in order to enjoy the aerosol generated from the aerosol-generating article. It may be possible to operate an aerosol-generating device with different reusable aerosol-generating articles. Different reusable aerosol-generating articles may include different mouthpieces. Different mouthpieces may comprise different materials, for example one or more of wood, paper, ceramic or plastic including biodegradable plastics. Different mouthpieces furthermore may comprise different designs. A user may choose to use different mouthpieces depending on their daily preference. The mouthpiece may be located at the downstream end of the aerosol-generating article.

As used herein, the terms “upstream”, and “downstream”, are used to describe the relative positions of components, or portions of components, of the aerosol-generating article or the aerosol-generating device in relation to the direction in which air flows through the aerosol-generating article or aerosol-generating device during use thereof along the air flow path. Aerosol generating articles according to the invention comprise a proximal end through which, in use, an aerosol exits the device. The proximal end of the aerosol generating article may also be referred to as the mouth end or the downstream end. The mouth end is downstream of the distal end. The mouth end may comprise a mouthpiece. The distal end of the aerosol generating article may also be referred to as the upstream end. Components, or portions of components, of the aerosol generating article may be described as being upstream or downstream of one another based on their relative positions with respect to the airflow path through the aerosol generating article.

The housing of the reusable aerosol-generating article may further comprise an air-flow path through the compartment to the mouthpiece. Such an air-flow path may easily pass any aerosol created in the compartment from the aerosol-forming substrate to the mouthpiece.

The housing of the reusable aerosol-generating article may comprise at least one air Inlet at the upstream end. The at least one air inlet may be located anywhere along the body of the housing. The airflow path therefore may extend from the at least one air Inlet at the upstream end of the housing through the compartment to the downstream and of the aerosol-generating article.

The air-flow path may further comprise an air-flow tube. The air-flow tube may be located between the mouthpiece and the compartment. The compartment may be located upstream of the air-flow tube. The mouthpiece may be located downstream of the air-flow tube. The airflow path through the reusable aerosol-generating article therefore may extend from the at least one air Inlet through the compartment end, to the air-flow tube to the downstream end of the aerosol-generating article.

The air-flow tube of the reusable aerosol-generating article may comprise a Venturi element. A Venturi element may assist in cooling down the aerosol formed in the compartment.

The Venturi element may comprise an airflow channel with an inlet portion, a central portion and an outlet portion. The inlet portion may be configured converging towards the central portion and the outlet portion may be configured diverging from the central portion. Such a Venturi element may improve cooling down of the aerosol.

Integrating such an air-flow tube into a reusable aerosol-generating article may provide an an air-flow path through the article in an easy way. The parts of the housing also may be pivotable about the hinge for providing access to the air-flow tube. This may ease the cleaning of the air-flow tube. It may be possible to include different designs of the air-flow tube in different reusable aerosol-generating articles. The different designs of the air-flow tube may influence one or both of velocity and pressure of the aerosol exiting at the downstream end of the reusable aerosol-generating article. Depending on their daily preference, a user may choose different reusable aerosol-generating articles. The user may choose different air-flow tubes. The user may choose different aerosol-generating articles with different air-flow tubes. The user may choose different air-flow tubes in order to receive a different experience during use of the reusable aerosol-generating articles.

The reusable aerosol-generating article may further include an additional airflow path. Such an additional airflow path may allow air to flow from one or more additional air inlet to the chamber, and out through the airflow tube. Such additional airflow path may be useful to provide additional airflow through the device. Or, such additional airflow path may cool the airflow, reducing the sensation of heat experienced by a user at the mouthpiece, and possibly improving the formation of aerosol in the device.

The aerosol-generating device may have a heating element. The heating element may be an element that heats the aerosol-forming substrate by conduction. For example, the heating element may be a resistive element lining the cavity into which the aerosol-generating article is inserted. Or, the aerosol-generating device may have a resistive blade or pin which extends into the cavity which contains the aerosol-generating article. Then, when the aerosol-generating article is inserted into the cavity in the aerosol-generating device, the resistive blade or pin is inserted into the aerosol-generating substrate contained in the aerosol-generating device to heat the aerosol-generating substrate.

In an alternative embodiment, the compartment of the reusable aerosol-generating article may comprise a heating element configured for heating the aerosol-forming substrate. A heating element in the compartment may heat the aerosol-forming substrate received in the compartment. Such a heating element may be located adjacent to the aerosol-forming substrate. For example the heating element may line the inner walls of the compartment. Alternatively, or additionally, such a heating element may be in direct contact with the aerosol-forming substrate. For example, the heating element may be in the form of a blade or a pin for heating the aerosol-forming substrate by conduction. Such a reusable aerosol-generating article with an integrated heating element may be used in conjunction with an aerosol-generating device which is devoid of a heating element. It may be easier to replace a defective heating element which is a part of the reusable aerosol-generating article in comparison to a heating element integrated into an aerosol-generating device.

The reusable aerosol-generating article may include both a heating element comprising a heating blade or a heating pin and a heating element lining the interior surface of the compartment A heating blade or heating pin may be able to penetrate the aerosol-forming substrate received in the compartment to heat the aerosol-forming substrate from the inside, while the heating element lining the interior surface of the compartment may heat the aerosol-forming substrate from the outside. This may improve the transfer of heat from the aerosol-generating article to the aerosol-forming substrate.

The heating element may comprise a susceptor heating element for heating the aerosol-generating substrate by induction. The susceptor may be part of the aerosol-generating device, or part of the aerosol-generating article, as described above. The susceptor may be formed from any material that can be inductively heated to a temperature sufficient to generate an aerosol from the aerosol-forming substrate received in the compartment. A preferred susceptor may comprise or consist of a ferromagnetic material, for example a ferromagnetic alloy, ferritic iron, or a ferromagnetic steel or stainless steel. A suitable susceptor may be, or comprise, aluminium. Preferred susceptors may be heated to a temperature in excess of 250 degrees Celsius.

Preferred susceptors are metal susceptors, for example stainless steel. However, susceptor materials may also comprise or be made of any one of graphite, molybdenum, silicon carbide, aluminum, niobium, Inconel alloys (austenite nickel-chromium-based superalloys), metallized films, ceramics such as for example zirconia, transition metals such as for example iron, cobalt, nickel, or metalloids components such as for example boron, carbon, silicon, phosphorus, aluminium, or combinations or alloys of materials.

The susceptor may be heated by an induction coil. The induction coil may provide an alternating magnetic field. The induction coil may be part of the aerosol-generating device or may be included in the reusable aerosol-generating article. When located in an alternating electromagnetic field, typically eddy currents are induced and hysteresis losses occur in the susceptor causing heating of the susceptor.

The compartment may comprise inner walls and the heating element may form at least a part of the inner walls of the compartment. In particular, a susceptor may form at least part of the inner walls of the compartment. The susceptor may comprise one or both of metal or ceramics for susceptive heating via creation of eddy currents. The compartment may comprise a metal cage configured for heating the aerosol-forming substrate. Such a metal cage may act as a susceptor and at the same time also may form the compartment for receiving the aerosol-forming substrate. Alternatively, the metal cage may be located within the compartment.

The compartment for receiving an aerosol-forming substrate may be detachably connectable to the reusable aerosol-generating article. This may ease the replacement of the compartment, separate from the housing of the reusable aerosol-generating article. The compartment may be replaced separate from the housing of the reusable aerosol-generating article if the compartment is worn or if any heating elements forming part of the compartment are defective.

In another embodiment, the reusable aerosol-generating article does not contain a heating element. Such a reusable aerosol-generating article may be used in conjunction with an aerosol-forming substrate which contains a heating element. In particular, the heating element may be a susceptor integrated into the aerosol-forming substrate. The aerosol-forming substrate may be contained in a substrate portion. The substrate portion may be a rod-like plug. A susceptor material may be integrated centrally in the interior of the substrate portion. The susceptor integrated into the aerosol-forming substrate may be heated by an inductive coil provided in the aerosol-generating device.

The compartment of the reusable aerosol-generating article may comprise holding elements configured for holding the aerosol-forming substrate within the compartment. In particular, these holding elements may be integrated into at least parts of the inner walls of the compartment. The holding elements may protrude from the inner walls into the interior of the compartment. The holding elements may have any shape. The holding elements may be wedge-shaped, wing-shaped, clasp-shaped, rectangular, square, triangular, rounded or shaped like teeth. The holding elements may comprise protrusions. The protrusions may comprise a cross-section tapering into the interior of the compartment. The protrusions may comprise teeth. These holding elements may further improve the positioning of the aerosol-forming substrate within the compartment. The heating blade or heating pin may be a holding element. The heating pin or a heating blade may penetrate the aerosol-forming substrate and may keep it in place. The above-mentioned holding elements having any shape, may be configured as additional holding elements which are present apart from the heating blade or heating pin.

The heating element may be integrated into the holding elements. The heating element may have any shape. The heating elements may be wedge-shaped, wing-shaped, clasp-shaped, rectangular, square, triangular, rounded or shaped like teeth. The heating element may comprise a protrusion. The protrusion may comprise a cross-section tapering into the interior of the compartment. The protrusion may comprise teeth. These elements may protrude from the inner side walls of the compartment into the interior of the compartment. These elements may penetrate an aerosol-forming substrate received in the compartment for holding the aerosol-forming substrate. These elements may comprise one or both of a susceptor material or a resistive heating material configured for heating the aerosol-forming substrate. The wedge-shaped or teeth-like elements may hold and at the same time heat the aerosol-forming substrate.

The compartment of the reusable aerosol-generating article may be configured for receiving a pre-shaped substrate portion containing the aerosol-forming substrate. The aerosol-forming substrate may be pressed or molded in order to provide a self-supporting substrate portion. The aerosol-forming substrate may be pre-packaged including a wrapper which may be wrapped around the substrate portion. This may ease the handling of the aerosol-forming substrate in comparison to employing loose aerosol-forming substrate. Loose aerosol-forming substrate may increase the difficulty of handling and may increase the amount of residue and dirt in the reusable aerosol-generating article due to spill-over. Alternatively, the reusable aerosol-generating article may comprise loose aerosol-forming substrate. The reusable aerosol-generating article may avoid spill-over of the loose aerosol-forming substrate into the cavity of an aerosol-generating device even if the substrate is loose.

The substrate portion comprising the aerosol-forming substrate may be rod-shaped. The compartment of the reusable aerosol-generating article may also be rod-shaped. This may ease the handling of the aerosol-forming substrate.

The aerosol-forming substrate may be any shape. The aerosol-forming substrate may be a plug of tobacco. The aerosol-forming substrate may be a plug of treated tobacco. The tobacco may cut, shredded, reconstituted, granulated, foamed, compressed, pelletized, extruded, agglomerated or powdered. The substrate may be formed from tobacco extract. The aerosol-forming substrate may be tobacco extract provided in a matrix. The aerosol-forming substrate may be a plug of plant material. The aerosol-forming substrate may be gel. The aerosol-forming substrate may be wrapped. The aerosol-forming substrate may be wrapped in paper. The aerosol-forming substrate may be contained in a container. The container may be, for example, a capsule. The aerosol-forming substrate may be treated with or combined with an aerosol-former. An aerosol-former may be, for example, glycerine. An aerosol-former may be propylene glycol. The aerosol-forming substrate may comprise a flavour agent. The flavour agent may be, for example, vanilla, cream, chocolate, maple, mint, menthol, mint, clove, molasses or other flavour agents.

In a further embodiment, the heating element comprised in the compartment of the reusable aerosol-generating article may be configured to hold the aerosol-forming substrate in position, when the aerosol-forming substrate is located in the compartment. In particular, the heating element may comprise two separate sections, in particular half-sections. The two separate sections of the heating element may be configured to hold the aerosol-forming substrate in the compartment during use.

In a further embodiment, the housing of the reusable aerosol-generating article may comprise at least one air inlet configured for providing air to the compartment. The air inlet may be fluidly connected with the compartment by an air channel. The air inlet may be located at the upstream end of the reusable aerosol-generating article. The air-flow path through the reusable aerosol-generating article may extend from the air inlet, through the air channel to the compartment and further through the air-flow tube to the downstream end of the article.

The housing of the reusable aerosol-generating article may comprise at least one first air Inlet being located distal of the compartment and at least one second air inlet being located proximal of the compartment. The distal position and the proximal position of the at least one first air Inlet and the at least second air inlet may be relative to an air-flow path leading from the distal or upstream end to the downstream or proximal end of the reusable aerosol-generating article.

In an embodiment, a set of first air inlets and a set of second air inlets may be present in the reusable aerosol-generating article. The term “set” may refer to a plurality of at least two first air inlets and to a plurality at least two second air inlets. For example, two first air inlets and two second air inlets may be present. Or, a plurality of first air inlets and a plurality of second air inlets may be present. These air inlets may be connected to the compartment by air channels.

The at least one first air inlet or the set of first air inlets may be connected to the compartment by first air channels defining a first airflow path from the first air inlets to the compartment of the reusable aerosol-generating article. The at least one first air Inlet or set of first air inlets may be located at the upstream end of the aerosol-generating article. The first airflow path may run parallel to a downstream air flow path leading from the compartment to the mouthpiece.

The at least one second air inlet or the set of second air inlets may be connected to the compartment by second air channels defining a second airflow path through the reusable aerosol-generating article to the compartment. Such a second airflow path may run at an angle with regard to the part of the air-flow path which may lead from the compartment to the mouthpiece. The at least one second air inlet may be located proximal to the compartment with regard to the above-mentioned air-flow path leading from the distal or upstream end to the downstream or proximal end of the reusable aerosol-generating article.

The first and second air flow path may merge in the compartment. There may be one single downstream air-flow path in the reusable aerosol-generating device. The downstream air-flow path may lead from the compartment to the mouthpiece.

Such an embodiment comprising a first air-flow path and a second air-flow path with a further downstream air flow path from the compartment to the mouthpiece may enable a reliable dissipation of heat. Furthermore, the second air-flow path may provide a particular good cooling effect.

In a further embodiment of the reusable aerosol-generating article, the housing may comprise a first section and a second section. The first section and the second section may be pivotable about the hinge. The first section and the second section may form parts of the compartment. The compartment may form when the first section and the second section are closed. Such an embodiment of the reusable aerosol-generating article may allow a particular easy closing of the aerosol-generating article via rotating both the first and the second section about the hinge.

The hinge may be located at the upstream end of the reusable aerosol-generating article. In particular, the hinge may be located at the upstream end of the first air-flow path to the compartment. Alternatively, the hinge may be located spaced away from the upstream end of the reusable aerosol-generating article. For example, the hinge may be located in the middle of the housing of the reusable aerosol-generating article or on the longitudinal axis of the housing of the reusable aerosol-generating article. Such a hinge may allow the housing to open about the hinge like a book. Both positions of the hinge may enable an easy pivoting of both the first and the second section in order to access the compartment.

The reusable aerosol-generating article may be cleanable or washable. In particular, the compartment of the aerosol-generating article may be easily accessible and therefore may be cleanable. The article may be opened up and placed in a dishwasher, for example. Similarly, if present, the air-flow tube of the reusable aerosol-generating article also may be cleanable. The heating element of the reusable aerosol-generating article, if present, also may be cleanable.

The reusable aerosol-generating article may comprise an elongated shape. Preferably, the reusable aerosol-generating article may comprise a rod-shape. The reusable aerosol-generating article may comprise a longitudinal axis. The longitudinal axis may be a central longitudinal axis.

The first section and the second section of the housing of the reusable aerosol-generating article may be in contact along the longitudinal axis of the reusable aerosol-generating article. In particular, the first section and the second section may form a first half-section and second half-section, which separate the housing into two separate half-sections of comparable size. The second section and the first section may be pivotable along the longitudinal axis of the reusable aerosol-generating article.

In a further embodiment of the reusable aerosol-generating article the first half-section and the second half-section comprise parts of the air-flow tube. The air-flow tube may be formed when the first half-section and the second half-section are closed by pivoting about the hinge. This ability to open the article may allow a particular easy cleaning of the air-flow tube providing easy access to all parts of the air-flow tube.

The first half-section and the second half-section may comprise parts of the mouthpiece. The mouthpiece may be formed when the first half-section and the second half-section are closed. Alternatively, the mouthpiece may comprise a one-piece element of the re-usable aerosol-generating article. Such a one-piece mouthpiece may be detachably attached to the downstream element of the reusable aerosol-generating article after both half-sections have been closed.

The reusable aerosol-generating article may have a tubular form or a rod shape with an upstream end face and with a downstream end face. Such a reusable aerosol-generating article furthermore may comprise a circumferential surface. One or more hinges may be located at the circumferential surface. The first and the second section may be pivotable about the one or more hinges. This may allow the first and second section of the reusable aerosol-generating article to be opened, similar to a book.

The reusable aerosol-generating article may comprise a support configured for supporting the aerosol-forming substrate in the compartment. Preferably, the support may be located at the upstream end of the compartment. The support may be formed as a platform on which the aerosol-forming substrate or substrate portion comprising the aerosol-forming substrate can be deposited. The support may furthermore comprise penetrating elements. These penetrating elements may penetrate into the aerosol-forming substrate in order to stably position the substrate within the compartment on the support. The penetrating elements may protrude into the interior of the compartment of the article. The penetrating elements may be shaped as pins, teeth, wedges, needles, tetrahedrons, pyramids, cubes or any other shape configured for penetrating the aerosol-forming substrate.

The housing of the reusable aerosol-generating article may comprise one or more of: metal, ceramic, polymers or composite polymeric material. These materials may enable the formation of a durable housing for the reusable aerosol-generating article. The polymers may be one or more of polyether ether ketone (PEEK), polyether ketone ketone (PEKK), polyphenylene sulfide (PPS) or Polyphenylene sulfide (PPS). The metal may be one or more of copper, magnesium, non ferromagnetic steel alloys like Austenitic stainless steel or martensitic stainless steel. The ceramic may be ceramic matrix composites (CMCs).

The mouthpiece of the reusable aerosol-generating article may comprise one or more of the materials of: polymer, rubber or wood. The mouthpiece furthermore may comprise a filter. The filter may prevent aerosol-forming substrate from entering the user's mouth.

The reusable aerosol-generating article may comprise a diameter between 4.5 mm and 12 mm, preferably better between 6.5 mm and 8 mm. The reusable aerosol-generating article may comprise a height of between 30 mm to 70 mm, preferably between 40 mm to 60 mm. The aerosol-forming substrate to be received in the compartment of the reusable aerosol-generating article may comprise a diameter of between 3 mm to 9 mm, preferably between 5 mm to 7.5 mm. The aerosol-forming substrate furthermore may comprise a height of between 5 mm to 15 mm, preferably from 7 mm to 10 mm.

Also provided is an aerosol-generating system which may comprise an aerosol-generating device including a cavity and a reusable aerosol-generating article as described herein. The cavity may be configured to receive said reusable aerosol-generating article.

The aerosol-generating system furthermore may comprise an aerosol-forming substrate. The aerosol-forming substrate may be a pre-shaped substrate portion as described herein. Such an aerosol-generating system can be employed in order to generate aerosol from the aerosol-forming substrate.

The reusable aerosol-generating article comprised in the aerosol-generating system may comprise a susceptor heating element and the aerosol-generating device may comprise an induction coil configured to generate an alternating magnetic field in the susceptor heating element, for heating the aerosol-forming substrate.

Alternatively, the reusable aerosol-generating article of the aerosol-generating system may comprise a resistive heating element and the cavity of the aerosol-generating device may comprise an electrical connection for providing power to the resistive heating element.

The aerosol-generating device of the aerosol-generating system may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The aerosol-generating device of the aerosol-generating system may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may power for example an induction coil comprised in the aerosol-generating article. Alternatively, the power supply may provide power to a resistive heating element comprised in the reusable aerosol-generating article via electrical connections.

The aerosol-forming substrate received in the compartment of the reusable aerosol-generating article may comprise a plug of formed aerosol-forming substrate. The plug may be a pressed or molded substrate portion containing the aerosol-forming substrate or it may be a pre-packaged substrate portion including a wrapper, such as paper being wrapped around the aerosol-forming substrate. The aerosol-forming substrate may also comprise a gel. The aerosol-forming substrate may comprise a non-volatile carrier material onto which volatile one or both of aerosol-formers and one or more active agents which can form part of the aerosol. Examples of non-volatile carrier material may be paper or cotton. The aerosol-forming substrate is a substrate capable of releasing volatile compounds that can form an aerosol. The volatile compounds may be released by heating the aerosol-forming substrate. The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. The aerosol-forming substrate may alternatively comprise a non-tobacco-containing material. The aerosol-forming substrate may comprise homogenised plant-based material.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol.

Provided is also the use of any of the reusable aerosol-generating articles described herein for the formation of an aerosol in an aerosol-generating device. The aerosol-generating device may include a cavity configured for receiving the reusable aerosol-generating article. Furthermore, an aerosol-forming substrate as described herein is received in the compartment of the reusable aerosol-generating article.

Features described in relation to one embodiment may equally be applied to other embodiments of the invention.

The invention will be further described, by way of example only, with reference to the accompanying figures in which:

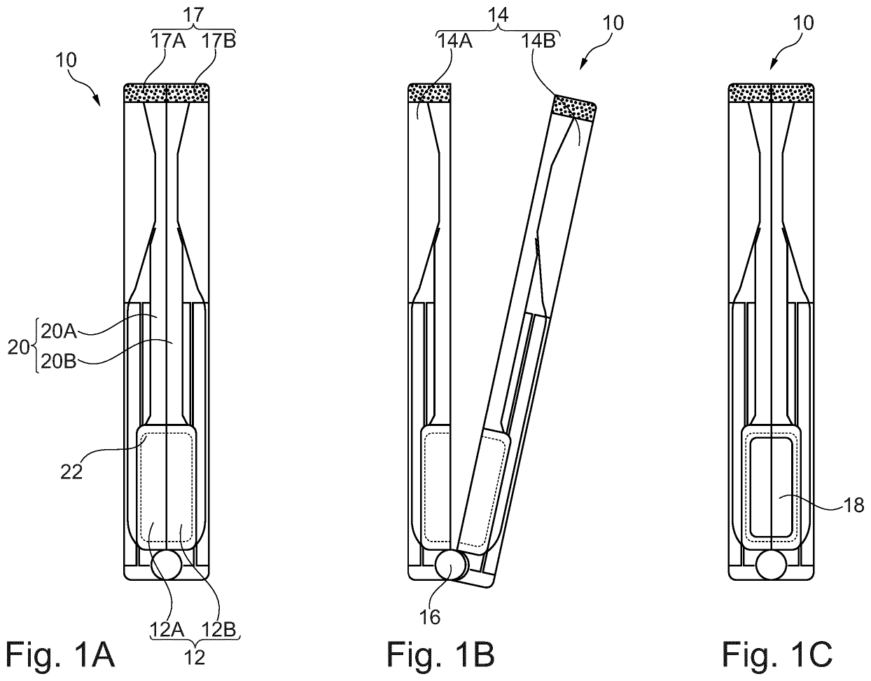

FIGS. 1A, 1B and 1C show a cross-section of a reusable aerosol-generating article in the open and closed state with a metal cage as a heating element;

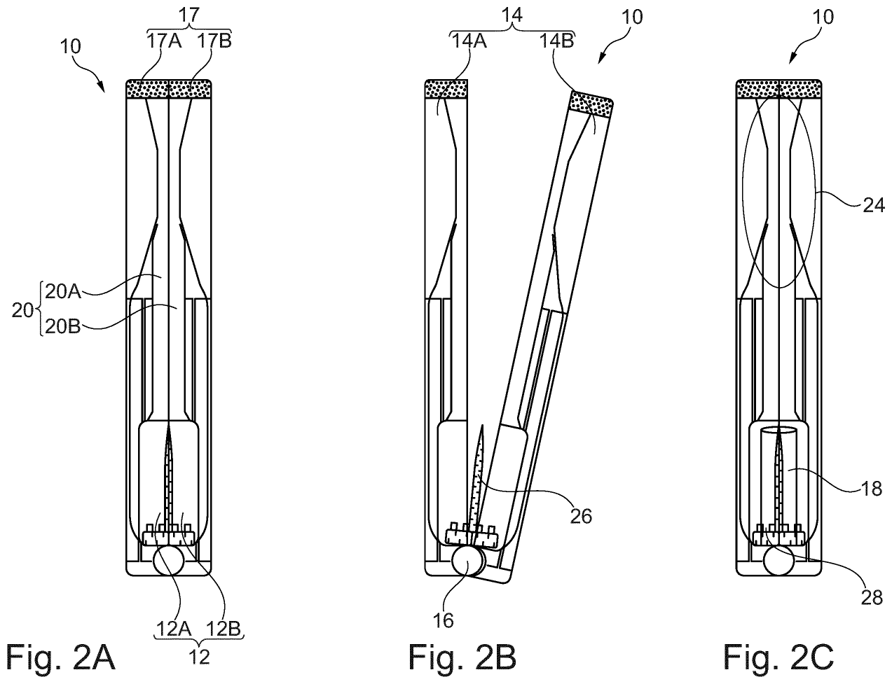

FIGS. 2A, 2B and 2C show a cross-section of a reusable aerosol-generating article in the open and closed state with a heating pin as a heating element;

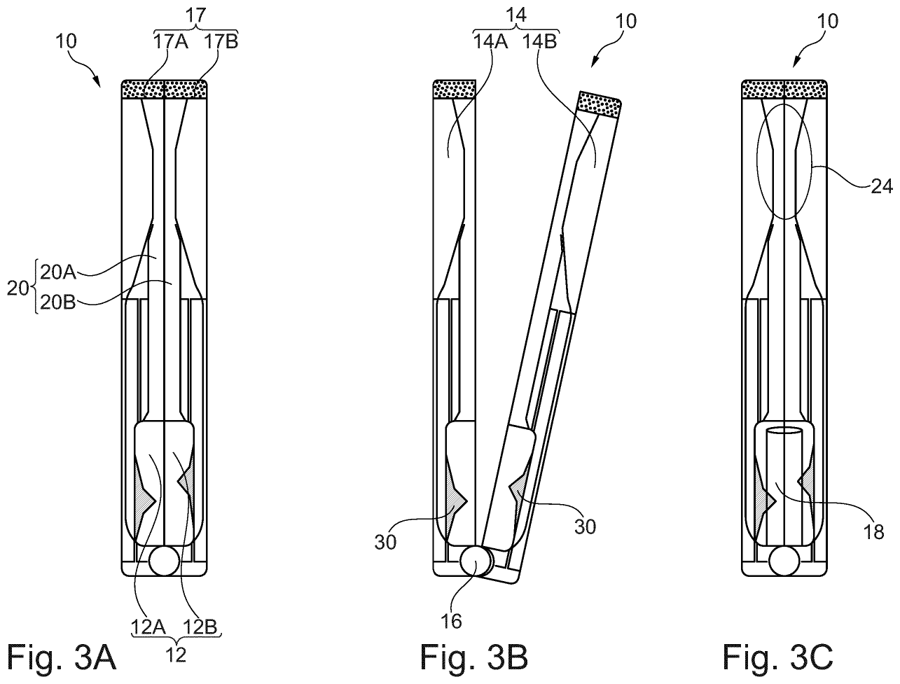

FIGS. 3A, 3B and 3C show a cross-section of a reusable aerosol-generating article in the open and closed state with combined holding and heating elements;

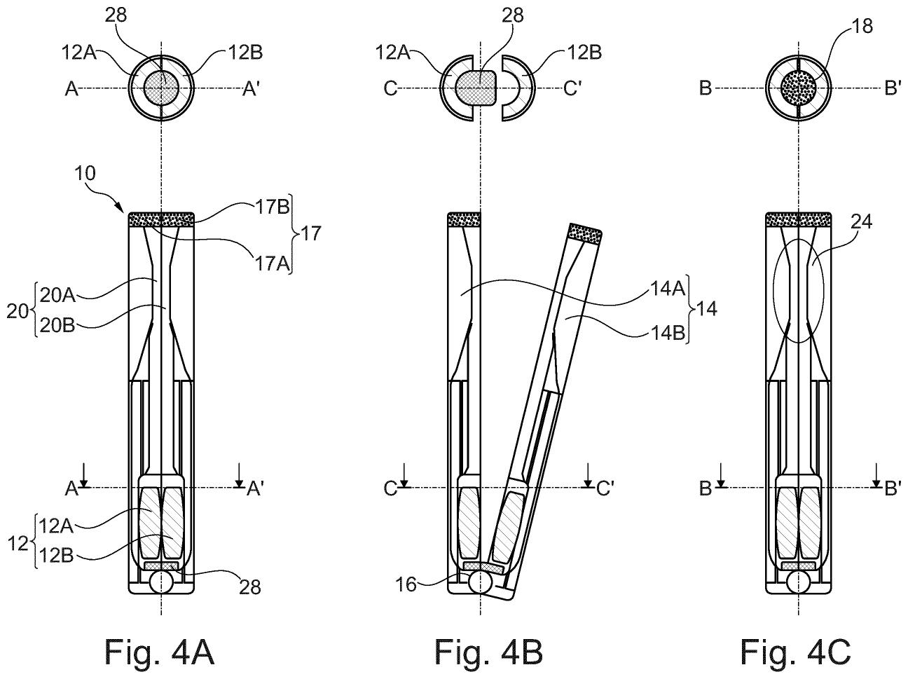

FIGS. 4A, 4B and 4C show in the upper parts a cross-sectional view of the reusable aerosol-generating article shown in cross-sectional view in the respective lower parts of the Figures;

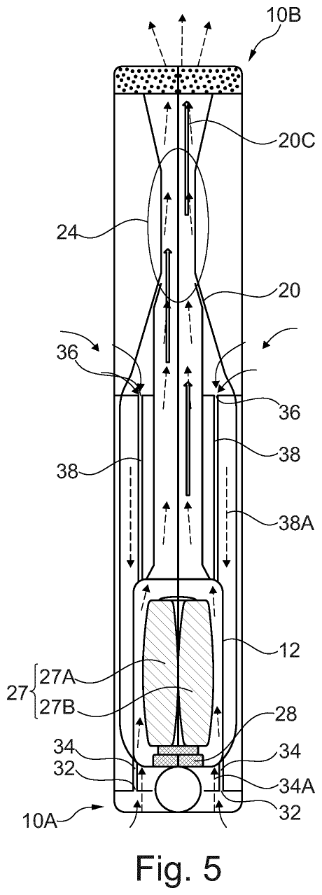

FIG. 5 shows the air flow path through one embodiment of a reusable aerosol-generating article in greater detail;

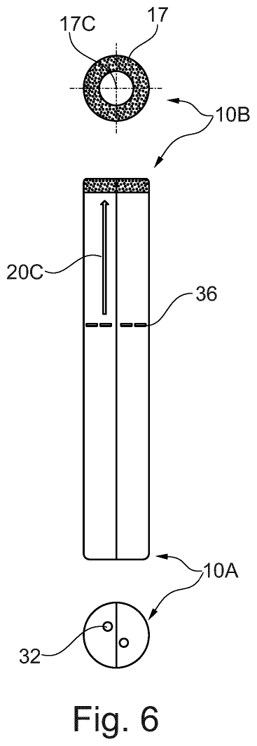

FIG. 6 shows top views of the upstream part and of the downstream part of the reusable aerosol-generating article shown in FIG. 5 together with a cross-sectional view;

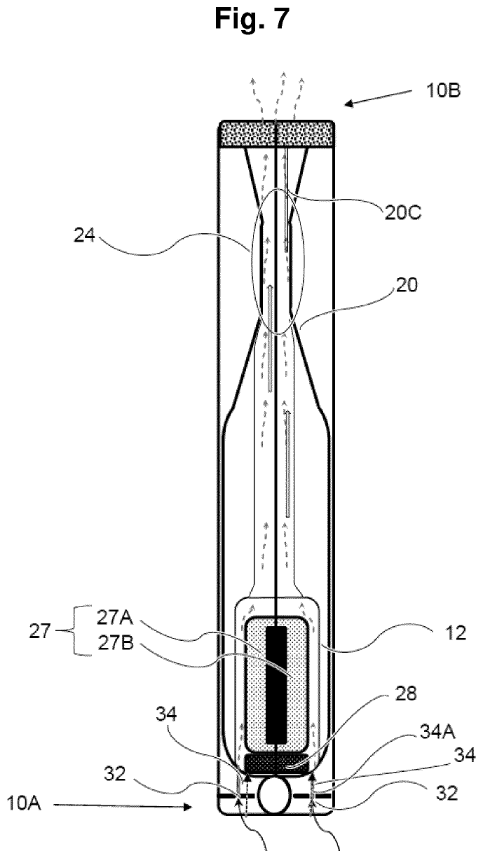

FIG. 7 shows the air flow path through another embodiment of a reusable aerosol-generating article with only one set of air inlets in greater detail;

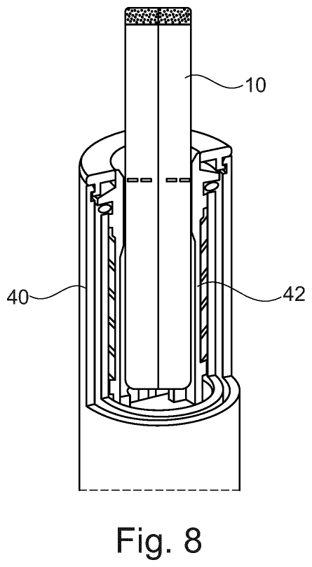

FIG. 8 shows a cross-section of an aerosol-generating system including an aerosol-generating device with a cavity and a reusable aerosol-generating article received in the cavity; and

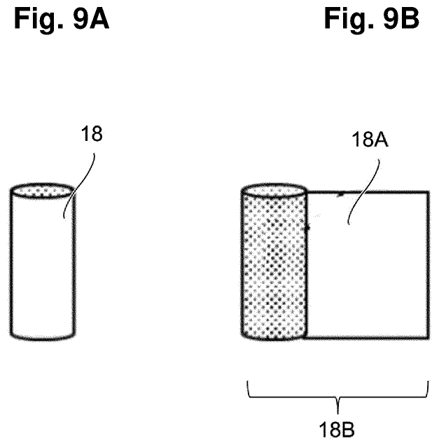

FIGS. 9A and 9B show a perspective view of a substrate portion made from pressed aerosol-forming substrate and a substrate portion including a wrapper surrounding the aerosol-forming substrate.

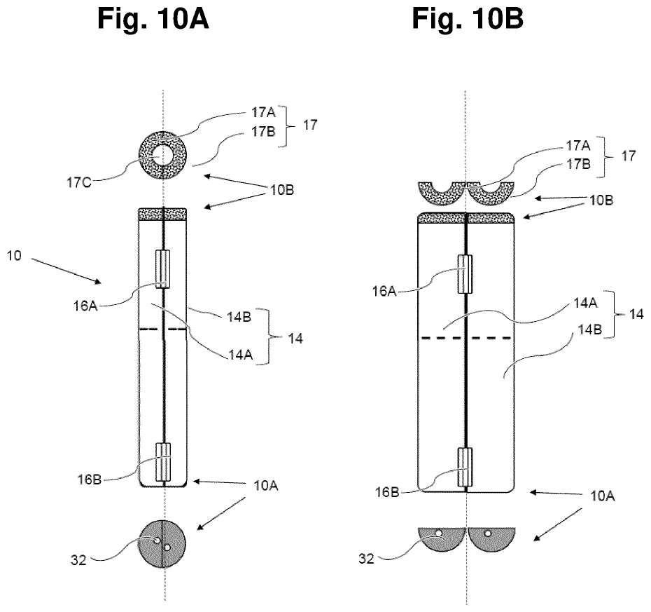

FIGS. 10A and 10B show top views of the upstream part and of the downstream part of a reusable aerosol-generating article with two hinges located on the circumferential surface of the article together with a cross-sectional view of this article;

In the following the same elements are marked with the same reference numerals throughout all the figures.

FIG. 1A depicts a cross-section of reusable aerosol-generating article 10 in the closed state and FIG. 1B shows the same reusable aerosol-generating article 10 in the open state. FIG. 1C on the right-hand side shows the closed reusable aerosol-generating article 10 after an aerosol generating substrate 18 was positioned within the compartment 12. The aerosol-generating article comprises a first half-section 14A and a second half-section 14B which together form the housing 14. Both half-sections are pivotable about a hinge 16, which provides access to the compartment 12 including a first half-section of the compartment 12A and a second half-section 12B. The compartment is configured to receive aerosol-forming substrate 18 as shown in FIG. 1C and additionally comprises a metal cage 22 as a heating element. This metal cage may serve as a susceptor and may be heated via an inductive coil present in an aerosol-generating device when applying a changing magnetic field to the susceptor. Alternatively, the metal cage may also include heating tracks configured for resistive heating. This metal cage also may comprise a first half-section and a second half-section which are located in the first half-section 14A and the second half-section 14B of the housing. Upon closing the housing, the metal cage can be formed by bringing both half-sections of the metal cage in contact with each other. In the open state an aerosol-generating substrate 18 can received in the compartment and subsequently the reusable aerosol-generating article can be closed again as shown in FIG. 1C providing an aerosol-generating article ready for use. The reusable aerosol-generating article also comprises a downstream air flow tube 20 which is formed by a first half-section 20A and a second half-section 20B. When closing the reusable aerosol-generating article by pivoting about the hinge 16 both half-sections of the downstream air flow tube come in contact with each other, thereby forming the airflow tube as shown both in FIG. 1A and FIG. 1C. The downstream end of the reusable aerosol-generating article is formed by the mouthpiece 17, which also comprises a first half-section 17A and a second half-section 17B. When opening the reusable aerosol-generating article by pivoting both half-sections about the hinge, the compartment becomes accessible so that aerosol-forming substrate or a substrate portion can be positioned with in the compartment 12. Additionally, in the open state the major internal components of the reusable aerosol-generating article, the compartment, the airflow tube and the mouthpiece become accessible and can easily be cleaned by for example using a brush. After having received the aerosol forming substrate 18, this substrate can be heated via metal cage 22 and an aerosol formed therefrom can be directed through the airflow tube 20 to the mouthpiece 17 and into the user's mouth.

FIG. 2A to 2C depict the same reusable aerosol-generating article as in the FIG. 1A to 1C with the exception that instead of a metal cage 20, a heating pin 26 is used as a heating element. This heating pin 26 is located on a support 28, which is a support platform. This support can support and position the aerosol-forming substrate 18 once it is received in the cavity 12 of the reusable aerosol-generating article. When positioning the aerosol-forming substrate 18 in the compartment 12 the heating pin 26 penetrates the aerosol-forming substrate (shown in FIG. 2C) so that the aerosol-forming substrate can be heated from the inside. The heating pin may provide a susceptor for heating the aerosol-forming substrate with an induction coil present in an aerosol-generating device by subjecting it to an alternating magnetic field. Alternatively, the heating pin may comprise heating tracks for resistive heating. The airflow tube 20 also comprises a Venturi element 24. The Venturi element comprises an upstream portion converging towards central portion and a downstream portion diverging from the central portion. Such a Venturi element may assist in the cooling of the aerosol created from the aerosol-forming substrate 18 received in the compartment 12.

FIG. 3A to 3C depict another embodiment of the reusable aerosol-generating article of the invention. Instead of a metal cage or a metal pin, holding/heating elements 30 are present in the compartment 12. These holding/heating elements 30 may comprise wedge-shaped elements. These holding/heating elements may comprise teeth elements which protrude from the inner walls of the compartment or from the bottom of the compartment into the interior of the compartment. When an aerosol-forming substrate 18 is received in the compartment and the reusable aerosol-generating article is closed, the holding/heating elements penetrate the aerosol-forming substrate 18 so that the aerosol-forming substrate is reliably held and positioned within the compartment 12. Additionally, the holding/heating elements 30 also allow a simple heating of the aerosol-forming substrate because they are direct contact with the substrate penetrating it. Similarly to the other heating elements shown in the FIG. 1A to 1C or FIG. 2A to 2C, the holding/heating elements can comprise a susceptor for susceptive heating via creation of eddy currents or can comprise resistors for resistive heating.

FIG. 4A to 4C show another embodiment of the reusable aerosol-generating article. In the upper part of each figure a cross-sectional view is shown which is drawn along the line indicated in the figure in the lower part. FIG. 4A depicts the reusable aerosol-generating article in the closed empty state without any aerosol-forming substrate located in the compartment. As it can be seen in the cross-sectional view in the upper part of FIG. 4A, a first half section 12A and a second half section 12B of the heating element of the article directly contact each other and form a circumferential heating element around the support 28. The support 28 is located near the upstream end of the aerosol-generating article and supports the aerosol-forming substrate when it is inserted into the compartment. FIG. 4B depicts the aerosol-generating article in the open state. While the first half section 12A of the heating element still contacts the support 28, the second half section 12B is distant from the support 28 due to the pivoting about the hinge 16 of the second section of the article and allows the insertion of an aerosol-forming substrate into the compartment. FIG. 4C depicts the aerosol-generating article in the closed state after insertion of a rod-shaped aerosol-forming substrate 18 in the compartment. The upper part of FIG. 4C shows that both the first section and the second section of the heating element abut the aerosol-forming substrate 18 and form a circumferential heating element around the aerosol-forming substrate, keeping it in its position within the compartment.

FIG. 5 shows in greater detail a cross-section of one embodiment of the reusable aerosol-generating article with an upstream end 10A and a downstream end 10B. The compartment 12 of this reusable aerosol-generating article comprises a metal susceptor 27 made of two half spheres 27A and 27B which can grab the rod-shaped aerosol-forming substrate from both sides when it is received in the compartment. Support 28 is present, which is located in the upstream part of the compartment 12 and which supports the aerosol-forming substrate (not shown in this figure because it is concealed by the metal susceptor 27). The upstream end 10A of the reusable aerosol-generating article includes first air-inlets 32 which are connected to the compartment 12 by first air-flow channels 34 and which provide a first air-flow path 34A from the upstream end into the compartment 12 indicated by dashed arrow when a user sucks on the mouthpiece at the downstream end 10B of the article. Additionally, second air inlets 36 are present in the aerosol-generating article, which are located distal of the compartment. These second air inlets 36 are fluidly connected to the compartment 12 by second air-flow channels 38. They provide a second air-flow path 38A (indicated by the dashed arrows) which runs at an angle with respect to the downstream air-flow path 20C which passes through the airflow tube 20. The second air-flow path 38A can run in opposite direction with regard to the downstream air-flow path 20C. Such a design of a first air flow path and a second airflow path enables an easy mixing and cooling of the aerosol. Both the first and the second air flow path merge in the compartment 12 and assist in the generation of an aerosol from the aerosol-forming articles received in the compartment upon heating. The aerosol formed is passed through the airflow tube 20 along the downstream air-flow path 20C (indicated by arrows) and through the Venturi element 24 for cooling. A user sucking at the mouth piece of the downstream end 10B of the article can inhale the aerosol.

FIG. 6 shows top views of the upstream end 10A and the downstream end 10B of the aerosol-generating article of FIG. 5. First air inlets 32 are visible in the top view of the upstream end 10A, whereas the mouth end opening 17C of the mouth end 17 can be seen at the downstream end of the reusable aerosol-generating article. Second air inlets 36 are located in the middle of the reusable aerosol-generating article as seen in the middle section of FIG. 6.

FIG. 7 shows another embodiment of the reusable aerosol-generating article of the invention. In contrast to the reusable article shown in FIG. 5, the article of FIG. 7 lacks second air inlets and only includes first air inlets 32. The article shown in FIG. 7 therefore has one air-flow path 20C leading from the first air inlets 32 located at the upstream end 10A of the article through the first air-flow channels 34 into the compartment 12 and then further through the airflow tube 20 to the downstream end 10B of the article.

FIG. 8 depicts a schematic drawing of an aerosol-generating system comprising an aerosol-generating device 40 with a cavity 42 including an induction coil. A re-usable aerosol-generating article 10 is received in the cavity and can be heated.

FIG. 9A depicts a perspective view of an aerosol-forming substrate 18, which is in a a rod-shaped form. Such a rod can for example be formed by molding or pressing the aerosol-forming substrate. Additionally, a wrapper 18A can be wrapped around the aerosol forming substrate 18 forming the substrate portion 18B as shown in FIG. 9B. These aerosol-forming substrates do not have to include additional elements such as filters or hollow cellulose acetate tubes (HAT) when being inserted into the compartment of the reusable aerosol-generating articles. This reduces the amount of waste.

FIGS. 10A and 10B depict another embodiment of the reusable aerosol-generating article of the invention. The top parts of both figures show top views of the downstream end 10B of the aerosol-generating article, whereas the lower parts of both figures show top views of the upstream end 10A of the article. The middle parts of both figures depict perspective views of the article. FIG. 10A shows the reusable aerosol-generating article in the closed state. A first section 14A is in contact with a second section 14B of the housing 14. Both sections, the first and second section are connected via two hinges 16A, 16B. The reusable aerosol-generating article is rod-shaped and both hinges 16 A, 16B are located at the circumferential surface of the article, so that the article can be opened by pivoting the first and the second section about both hinges, like a book. This is clearly visible in the top part of the FIG. 10B, which depicts a top view of the reusable aerosol-generating article in the open state. The mouthpiece 17 comprises a first section 17A and a second section 17B with a mouth end opening 17C, which is formed when both sections are closed and contact each other. The upstream part 10 A of the aerosol-generating article includes first air inlets 32.

1.-15. (canceled)

16. A reusable aerosol-generating article configured to be received into a cavity of an aerosol-generating device, the reusable aerosol-generating article comprising:
a housing comprising a compartment configured to receive an aerosol-forming substrate,
wherein at least parts of the housing are pivotable about a hinge and configured to provide access to the compartment; and
a mouthpiece,
wherein the housing further comprises an air-flow path through the compartment to the mouthpiece.

17. (canceled)

18. The reusable aerosol-generating article according to claim 16, further comprising an air-flow tube arranged downstream of the compartment, wherein the parts of the housing being pivotable about the hinge provide access to the compartment and the air-flow tube.

19. The reusable aerosol-generating article according to claim 16, wherein the air-flow path comprises the air-flow tube.

20. The reusable aerosol-generating article according to claim 16, wherein the compartment comprises a susceptor heating element or a resistive heating element configured to heat the aerosol-forming substrate.

21. The reusable aerosol-generating article according to claim 16,
wherein the compartment comprises inner walls,
wherein the compartment further comprises holding elements configured to hold the aerosol-forming substrate within the compartment.

22. The reusable aerosol-generating article according to claim 21, wherein the holding elements protrude from the inner walls into an interior of the compartment.

23. The reusable aerosol-generating article according to claim 20, wherein the susceptor heating element or the resistive heating element comprises a heating blade or heating pin.

24. The reusable aerosol-generating article according to claim 16, wherein the compartment is configured to receive a pre-shaped substrate portion containing the aerosol-forming substrate.

25. The reusable aerosol-generating article according to claim 16, wherein the compartment is rod-shaped and is configured to receive a rod-shaped substrate portion.

26. The reusable aerosol-generating article according to claim 16,
wherein the housing further comprises at least one air inlet configured to provide air to the compartment, and
wherein the air inlet is fluidly connected with the compartment by an air channel.

27. The reusable aerosol-generating article according to claim 26, wherein the housing further comprises at least one first air inlet being located distal of the compartment and at least one second air inlet being located proximal of the compartment.

28. The reusable aerosol-generating article according to claim 16,
wherein the housing further comprises a first section and a second section,
wherein the first section and the second section are pivotable about the hinge, and/or
wherein the hinge is located at an upstream end of the reusable article.

29. The reusable aerosol-generating article according to claim 28, wherein both the first section and the second section comprise parts of the compartment, the compartment being formed when the first section and the second section are closed.

30. The reusable aerosol-generating article according to claim 28, wherein both the first section and the second section comprise parts of the air-flow tube, the air-flow tube being formed when the first section and the second section are closed.

31. The reusable aerosol-generating article according to claim 16, wherein the housing further comprises one or more of metal or ceramic.

32. The reusable aerosol-generating article according to claim 16, wherein the reusable aerosol-generating article comprises a rod-shape.

33. The reusable aerosol-generating article according to claim 16, wherein the hinge is located on a longitudinal axis of the housing.

34. An aerosol-generating system, comprising an aerosol-generating device including a cavity, and a reusable aerosol-generating article according to claim 16, wherein the cavity is configured to receive the reusable aerosol-generating article.

35. The aerosol-generating system according to claim 34, wherein the reusable aerosol-generating article further comprises a susceptor heating element and the aerosol-generating device comprises an induction coil configured to generate an alternating magnetic field in the susceptor heating element.
